(19) United States
(12) Patent Application Publication
(10) Pub. No.: US 2014/0361109 A1
(43) Pub. Date: Dec. 11, 2014

(54) MULTILAYERED FILM ROLL WITH REDUCED DEFECTS

(71) Applicant: Eastman Chemical Company, Kingsport, TN (US)

(72) Inventors: Shiwei Liu, Stevenson Ranch, CA (US); Mohtashim Saif, Chino, CA (US); Hsifu Fan, Yangmei City (TW); Hua Ching Mark Lin, Zhunan Township (TW); Stefaan Florquin, Grez-Doiceau (BE); Ke Qin Thomas Yang, Taipei City (TW)

(73) Assignee: Eastman Chemical Company, Kingsport, TN (US)

(21) Appl. No.: 13/945,526

(22) Filed: Jul. 18, 2013

Related U.S. Application Data
(60) Provisional application No. 61/833,170, filed on Jun. 10, 2013.

(51) Int. Cl. B65H 18/10; B05D 3/12

(52) U.S. Cl. CPC B65H 18/103; B05D 3/12; B65H 2601/2531
USPC 242/160.4; 427/177; 34/523; 34/92; 34/406

(57) ABSTRACT

Devices, systems, and methods for preventing or reducing raised edges in wound films are disclosed herein. This improvement can be accomplished by employing a roll spacer that is narrower than the film and/or by entrapping a gas between the layers in the wound film. One or more embodiments of the present invention concern a multilayered wound film roll.

### RELATED APPLICATIONS

This application claims the priority benefit under 35 U.S.C. §119(e) of U.S. Provisional Patent Application Ser. No. 61/833,170 filed Jun. 10, 2013, the entire disclosure of which is incorporated herein by reference.

### BACKGROUND

1. Field of the Invention

The present invention generally relates to devices, systems, and methods for preventing or reducing defects in wound films caused by raised edges. More particularly, the present invention relates generally to devices, systems, and methods for preventing or reducing the presence of raised edges while winding a film in a vacuum.

2. Description of the Related Art

Roll-to-roll processing methods have been widely used in vacuum deposition processes in order to coat various functional materials onto flexible substrates, such as films. A conventional roll-to-roll process is depicted in FIG. 1. As shown in FIG. 1, the roll-to-roll process 10 usually involves unwinding a roll of raw film 12, coating the unwound raw film 14 with the desired coating in a deposition system 16, and rewinding the coated film 18 onto a cylindrical central support assembly to form a multilayered wound coated film roll 20. These wound coated films can be easily transported to various customers for further use or processing. Thus, a good roll formation during the roll-to-roll process is critical for customers to be able to correctly unwind the roll during subsequent use or processing. In addition, a good roll formation also provides aesthetic benefits since the wound film roll will generally exhibit fewer defects and wrinkles.

An issue with the wound films is that defects can easily be generated at one or both edges of the wound film, which often causes a local non-uniformity of thickness between the body of the film and the edges. This local-non-uniformity can be especially highlighted during roll rewinding in a vacuum, thereby leading to raised edges to be formed on the wound film roll. As the raised edges grow up on the wound film roll, unsightly wrinkles can be generated on the roll.

The local non-uniformity at edges can come from poor slitting, which can raise the edges of polymer films since blunt knives can distort the polymer and cause hot edge shrinking back and thickening by generating heat. Improper handling or contamination at the edges could also introduce debris and other defects that thicken the edges during winding.

Generally, the non-uniformity in edge thickness can be less visible in a roll wound in air because there will be a thin boundary layer of air dragged along with each film surface. The air layers will be trapped between each film layer and smoothen the edges' non-uniformity. However, after this kind of roll is unwound for processing, the web has to be rewound on a core to form a roll in vacuum again. During this time, the entrapped air will be quickly released. Consequently, the edges will thicken up during winding and grow bigger than the rest of the film until the edges fold and are raised. As the edges grow in thickness, all the tension can be concentrated thereon and cause very high localized hardness in the roll. The raised edges can also impede the further winding of the film and may cause the formation of permanent wrinkles on the roll.

Conventionally, the issue of raised edges has been addressed by oscillating the film during the winding to even out the non-uniform thickness of the film edges. Different methods and apparatus have been disclosed for oscillating the films. For example, U.S. Pat. No. 8,100,356 described an in-process apparatus comprised of a retractable idler roll and a film roll separated from the retractable idler roll by an air gap that remains constant as the film is wound onto the film roll. U.S. Pat. No. 5,531,393 discloses an apparatus where the roll onto which the film is wound is oscillated. The oscillation is controlled by a piston reciprocating between two limit positions, which moves a cap inserted into the hollow end of the film roll.

The oscillating approach generally requires a delicate apparatus that can control the transverse movement of the winding film precisely. The apparatus usually requires constant maintenance and calibration. Furthermore, its implementation in existing roll-to-roll equipment often is difficult because of the limited space and significant modification of the existing transportation system. The final film roll with a jagged film pattern usually has to be reversely oscillated in air or a vacuum to recover the straight film stacking for further processing. The transverse movement of the winding film could also generate fine scratches that could limit the application of the wound film for some high-quality products.

Accordingly, there is a need for devices, systems, and methods for winding a film on roll core that prevents or reduces the formation of raised edges in wound films.

### SUMMARY

One or more embodiments of the present invention concern a multilayered wound film roll. The multilayered wound film roll comprises a central support assembly and a film wound around the central support assembly. The central support assembly presents an outer support surface that contacts an initial wound layer of the film. The film comprises a main film body and a pair of outer edges extending along opposite sides of the main film body. The average thickness of the outer edges is greater than the average thickness of the main film body. Furthermore, the width of the outer support surface is less than the width of the initial wound layer of the film so that the outer edges of the initial wound layer of the film are not in contact with the outer support surface.

One or more embodiments of the present invention concern a process for producing a multilayered wound film roll. The process comprises winding a film around a central support assembly to thereby form the multilayered wound film roll. The central support assembly presents an outer support surface that contacts an initial wound layer of the film during the winding. Furthermore, the width of the outer support surface is less than the width of the initial wound layer of the film so that the outer edges of the initial wound layer of the film are not in contact with the outer support surface.

One or more embodiments of the present invention concern a vacuum roll-to-roll device. The device comprises a roller configured to wind an initial film around a core thereby forming a wound film comprising a plurality of film layers; a rewind-controlling member configured to maintain a constant distance from the outermost layer of the wound film on the roller; and a gas injection system configured to introduce a gas to be entrapped between the film layers during the winding on the roller. The entrapped gas is able to reduce the edge pressure of the wound film and/or minimize the thickness variation amongst the edges in the wound film.

One or more embodiments of the present invention concern a process for producing a multilayered film roll. The process comprises winding a film around a central support assembly in a vacuum to thereby form the multilayered wound film roll having a plurality of film layers. During the winding, a gas is injected between the film layers immediately before the film is wound around the central support assembly.

### BRIEF DESCRIPTION OF THE FIGURES

Embodiments of the present invention are described herein with reference to the following drawing figures, wherein:

FIG. 1 is a schematic depiction of a conventional roll-to-roll film process;

FIG. 2 is a cross-sectional depiction of a wound film roll comprising a spacer and film surrounding a rolling core;

FIG. 2A is a close up view of the edges of the spacer, film, and rolling core in FIG. 2;

FIG. 3A is a flow diagram depicting the steps for producing a wound film roll with a narrow leader film according to one embodiment;

FIG. 3B is a flow diagram depicting the steps for producing a wound film roll with a narrow leader film according to an alternative embodiment;

FIG. 4 is a cross-sectional depiction of a wound film roll comprising a film wrapped around a rolling core having straight cut edges;

FIG. 4A is a close up view of the edges of the film and rolling core in FIG. 4;

FIG. 5 is a cross-sectional depiction of a wound film roll comprising a film wrapped around a rolling core having tapered edges;

FIG. 5A is a close up view of the edges of the film and rolling core in FIG. 5;

FIG. 6 is a cross-sectional depiction of a wound film roll comprising a film wrapped around a rolling core having open gaps at its edges;

FIG. 6A is a close up view of the edges of the film and rolling core in FIG. 6; and

FIG. 7 is a schematic depiction of a roll system comprising a gas-entrapping device configured in accordance with an embodiment described herein.

### DETAILED DESCRIPTION

The following description is not to be taken in a limiting sense, but is made merely for the purpose of illustrating the general principles of the disclosure, since the scope of the present disclosure should be best defined by the claims.

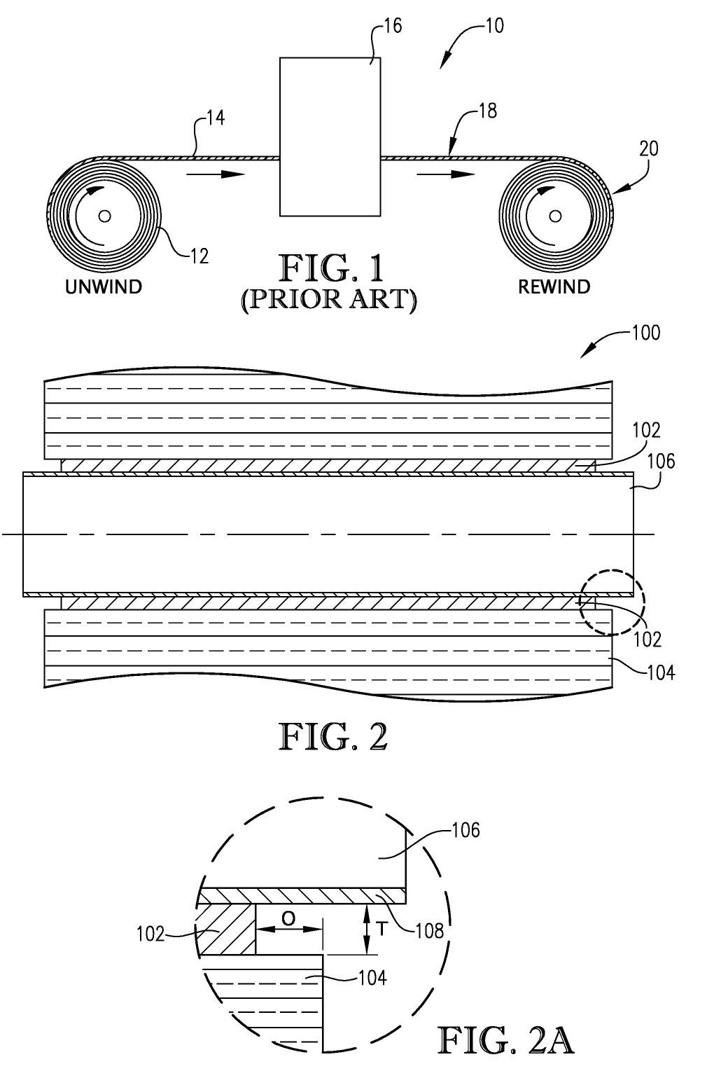

In order to better facilitate the subsequent discussion regarding the multilayered wound film rolls, the initial focus is placed on the conventional roll-to-roll system depicted in FIG. 1, which depicts how a multilayered wound coated film roll 20 can be created. It should be understood that the system shown in FIG. 1 is just one example of a system within which the present invention can be embodied. The present invention may find application in a wide variety of other systems where it is desirable to produce multilayered wound film rolls.

Generally, as shown in FIG. 1, the roll-to-roll process involves unwinding a roll of a raw film 12, coating the raw film 14 with the desired coating in a deposition system 16, and rewinding the coated film 18 onto a cylindrical central support assembly to form a multilayered wound coated film roll 20.

The technology described herein is generally directed to devices, systems, and methods for preventing or reducing the generation of raised edges and the formation of wrinkles in the multilayered wound film rolls produced by roll-to-roll processes. In various embodiments described herein, the formation of the raised edges in the multilayered wound film rolls can be mitigated by reducing the edge pressure of the film against the central support assembly during winding. As discussed below in further detail, this can be accomplished by reducing the pressure between the edges of the wound film and the central support assembly and/or by entrapping a gas between the layers in the wound film to even the non-uniformity in the film's edges. As a result, little or no wrinkles can be generated on the multilayered wound film rolls during the winding of the film.

As described below in further detail, this reduction in edge pressure can be achieved using a spacer, a gas entrapping device, or a combination thereof. These spacers can include, for example, narrow leader films, foams, and special designs of the rolling cores used to wind the films.

In various embodiments, the present invention is directed to a process that comprises winding a film around a central support assembly to thereby form the multilayered wound film roll. In such embodiments, the central support assembly can present an outer support surface that contacts an initial wound layer of the film during the winding. The wound film in the multilayered wound film roll can comprise a main film body and a pair of outer edges extending along opposite sides of the main film body that define the width of the film. In certain embodiments described further below, the central support assembly can be formed of a rolling core and a spacer that forms and presents the outer support surface. Moreover, in one or more embodiments, the processes described herein can occur in a vacuum.

More specifically, the process of the present invention can involve: (a) attaching a film and a spacer presenting an outer support surface to one another; (b) winding the spacer around a rolling core (if applicable); and (c) winding the film around the rolling core and spacer. Thus, the spacer can be first wound around the rolling core followed by the film. Consequently, the spacer can at least partially separate the wound film from the rolling core in the multilayered wound film roll. In various embodiments described further below, the spacer can be separate and distinct from the rolling core or can be part of the rolling core. Furthermore, the spacer can be separately attached to the rolling core before or after being attached to the film prior to winding.

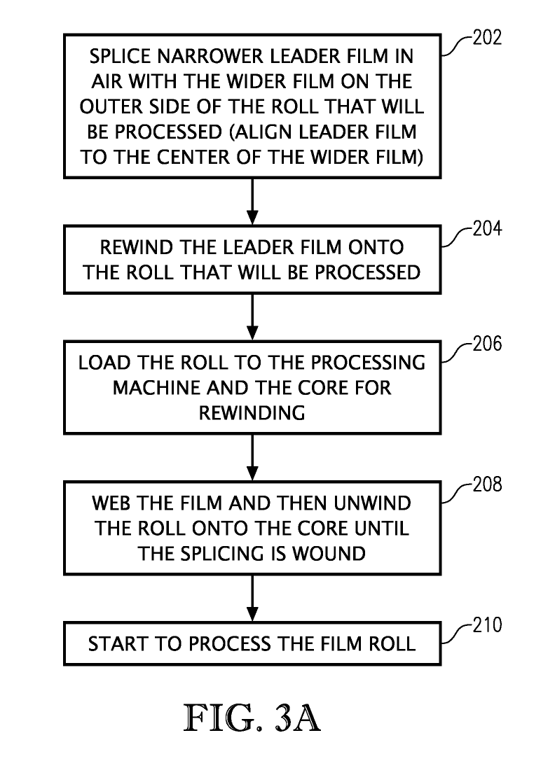

FIG. 2 shows a cross-sectional schematic depiction of a multilayered wound film roll 100 formed in accordance with the present invention. The multilayered wound film roll 100 has a spacer 102 and a film 104, both of which extend around and are supported by a rolling core 106. As depicted in FIG. 2, the spacer 102 presents a film contact surface having a narrower width than film 104. This difference in width is emphasized in FIG. 2A, which shows a close-up view of the edges of the spacer 102, film 104, and rolling core 108. As shown in FIG. 2A, since the edges of the film 104 extend past the edges of the contact surface of the spacer 102 to form an overhang (the length of which is depicted by “O”), the edges of the film 104 can be free of pressure that would otherwise cause raised edges by pressing against the hard rolling core. Consequently, the occurrence of raised edges in the multilayered wound film roll can be significantly reduced and/or delayed. In addition, FIG. 2A shows that the thickness (“T”) of the spacer is determined by measuring from the surface of the film 104 to the surface of the rolling core 108.

In one or more embodiments, the width of the outer support surface of the central support assembly can be less than the width of the wound film in the multilayered wound film roll. For example, the outer edges of the film in the multilayered wound film rolls can extend at least about 0.5, 1, 5, or 10 mm and/or not more than about 500, 200, 100, or 50 mm beyond the edges of the outer support surface. More specifically, the outer edges of the film in the multilayered wound film rolls can extend in the range of 0.5 to 500 mm, 1 to 200 mm, 5 to 100 mm, or 10 to 50 mm beyond the outer support surface.

Due to this greater width, the outer edges of the film in the multilayered wound film roll may not be in contact with the outer support surface of the central support assembly in these situations. Consequently, such configurations may decrease the pressure on the edges of the wound films and thereby prevent or reduce the generation of raised edges and wrinkles in the multilayered wound film rolls.

In the process described herein, the average thickness of the outer edges of the film being processed can be at least about 0.00001, 0.0001, 0.001, or 0.01 percent and/or not more than 10, 5, 2, 1 percent thicker than the average thickness of the main film body (i.e., the central portion of each film layer located between the outer edges of the film layer). More specifically, the average thickness of the outer edges can be 0.00001 to 10 percent, 0.0001 to 5 percent, 0.001 to 2 percent, or 0.01 to 1 percent thicker than the average thickness of the main film body.

In one or more embodiments, the multilayered wound film rolls can comprise at least about 100, 500, or 1,000 and/or not more than about 100,000, 50,000, or 20,000 wound layers of the film. More specifically, the multilayered wound film rolls can comprise 100 to 100,000, 500 to 50,000, or 1,000 to 20,000 wound layers of the film. Additionally, the average thickness of each layer in the main film body of the multilayered wound film rolls can be at least about 0.5, 1, 5, or 10 μm and/or not more than about 1,000, 250, 100, or 75 μm. More specifically, the average thickness of each layer in the main film body of the multilayered wound film rolls can be in the range of 0.5 to 1,000 μm, 1 to 250 μm, 5 to 100 μm, or 10 to 75 μm.

The film in the multilayered wound film roll can also have an unwound length that varies depending on the desired end use application of the film. For example, in various embodiments, the film in the multilayered wound film roll can have an unwound length of at least about 1, 25, or 100 m and/or not more than about 10,000, 5,000, or 1,000 m. More specifically, the film in the multilayered wound film roll can have an unwound length in the range of 1 to 10,000 m, 25 to 5,000 m, or 100 to 1,000 m.

The film in the multilayered wound film roll can also have a width that varies depending on the desired end use application of the film. For example, in various embodiments, the film in the multilayered wound film roll can have an average width of at least about 1, 25, or 100 mm and/or not more than about 5,000, 2,500, or 1,000 mm. More specifically, the film in the multilayered wound film roll can have an average width in the range of 1 to 5,000 mm, 25 to 2,500 mm, or 100 to 1,000 mm.

The film in the multilayered wound film roll can be produced from any polymeric material or metal foil known in the art. For example, the multilayered film can comprise any thermoplastic polymer known in the art that is able to undergo roll-to-roll processing. In one or more embodiments, the film can comprise polyethylene terephthalate, polybutylene terephthalate, polyethylene naphthalate, polyethersulfone, polyethylene, polypropylene, polyamide, acrylics, glass, metal foils, and/or any derivatives thereof. Furthermore, the films used to produce the multilayered wound film rolls can comprise coated films that have been previously subjected to a coating process.

As previously noted, in one or more embodiments, the central support assembly can comprise a rolling core and a spacer. The rolling core can generally comprise a cylindrical core upon which the film can be wound during the process. The diameter of the core can vary depending on the type of core and the intended end use of the multilayered wound film roll. For example, the rolling core can have a diameter of at least about 1, 10, or 25 mm and/or not more than about 1,000, 250, or 100 mm. More specifically, the rolling core can have a diameter in the range of 1 to 1,000 mm, 10 to 250 mm, or 25 to 100 mm. The core can be formed, for example, from a cardboard, plastic, or metal material.

As previously noted, the central support assembly can also comprise a spacer. The spacer can be at least partially disposed between the rolling core and the film in the multilayered wound film roll. Furthermore, the spacer can form and present the outer support surface of the central support assembly. Thus, the spacer can reduce the pressure between the outer edges of the film and the rolling core thereby minimizing raised edges in the multilayered wound film roll.

The thickness of the spacer in the multilayered wound film roll can vary depending on the type of spacer used and the end use of the multilayered wound film roll. In one or more embodiments, the spacer can have an average thickness (“T”) of at least about 0.1, 0.5, 1, or 5 mm and/or not more than about 500, 100, 50, or 25 mm. More specifically, the spacer can have an average thickness in the range of 0.1 to 500 mm, 0.5 to 100 mm, 1 to 50 mm, or 5 to 25 mm.

The width of the outer support surface of the spacer in the multilayered wound film roll can vary depending on the type of spacer used and the end use of the multilayered wound film roll. In one or more embodiments, the spacer can have an average width of at least about 1, 10, or 50 mm and/or not more than about 4,000, 2,000, or 500 mm. More specifically, the spacer can have an average width in the range of 1 to 4,000 mm, 10 to 2,000 mm, or 50 to 500 mm.

FIGS. 2 and 4-6 depict various types of spacers that may be used in conjunction with the present invention. In various embodiments described herein, the spacer as shown in FIGS. 2 and 2A can comprise a narrow leader film. The narrow leader film can be attached and placed ahead of the film during winding. In one or more embodiments, the narrow leader film in the multilayered wound film roll can comprise a plurality of layers. The thickness of each individual layer can depend on the type of leader film used. For example, each film layer making up the wound narrow film leader in the multilayered wound film roll can comprise an average thickness of at least about 0.1, 1, 10, or 25 μm and/or not more than about 1,000, 500, 250, or 100 μm. More specifically, each film layer making up the wound narrow film leader in the multilayered film roll can comprise an average thickness in the range of 0.1 to 1,000 μm, 1 to 500 μm, 10 to 250 μm, or 25 to 100 μm. In certain embodiments, the rolling core can be formed from a plurality of narrow leader film layers.

The length of the narrow film leader can vary depending on the type of film and the end use of the multilayered film roll. For example, the narrow film leader can have a length of at least about 10, 50, or 100 mm and/or not more than about 500, 100, or 10 m. More specifically, the narrow film leader can have a length in the range of 10 mm to 500 m, 50 mm to 100 m, or 100 mm to 10 m. In various embodiments, the narrow film leader can comprise polyethylene terephthalate, polybutylene terephthalate, polyethylene naphthalate, polyethersulfone, polyethylene, polypropylene, polyamide, acrylics, glass, metal foils, and/or any derivatives thereof.

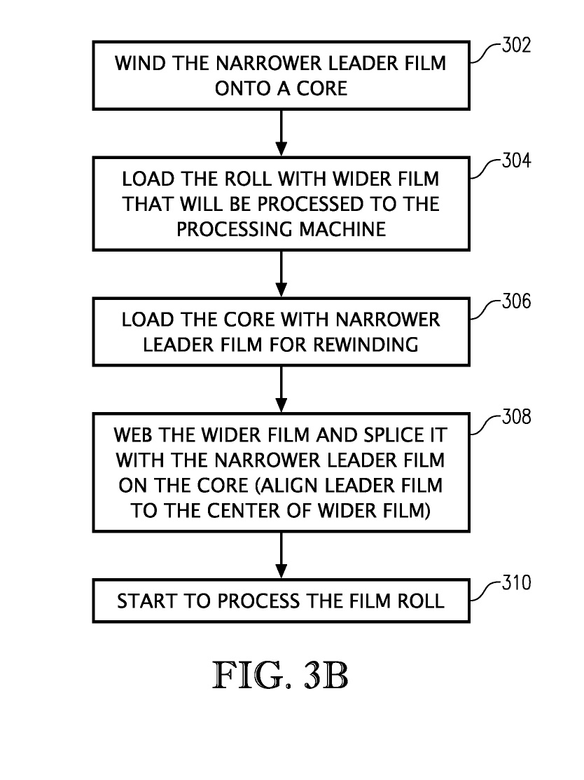

FIGS. 3A and 3B are flow charts depicting different processes of using a narrow film leader as the spacer. As illustrated in FIG. 3A, the narrower leader film can be spliced in air with a wider film on the outer side of the roll that will be processed (step 202). The leader film can be aligned with the center portion of the wider film so that the edges of the wider film can be free (step 202). The leader film can be rewound onto the roll (step 204) and then the roll can be loaded into the processing machine (step 206). Afterwards, the film can be webbed and then wound onto a standard core until the splicing is wound (step 208). Once the splicing is wound, the film roll can be processed (step 210).

An alternative process is illustrated in FIG. 3B. Initially, the leader film can be directly wound on a core (step 302). The roll with the wider film can then be loaded into the machine (step 304). Next, the core with the leader film attached can be loaded for rewinding (step 306). The wider film can then be webbed and spliced with the narrower leader film that has already been wound on the core (step 308). Subsequently, the resulting roll can be processed (step 310).

In various embodiments described herein, the spacer 102 as shown in FIGS. 2 and 2A can comprise a layer of elastically or plastically deformable foam material that surrounds the rolling core 106. The foam material can be, for example, a polystyrene foam (Styrofoam™) or a polyurethane foam. In addition, the foam can be used to enhance the performance of the rolling core by cushioning the higher pressure at the edges as well as reducing the overall core impression.

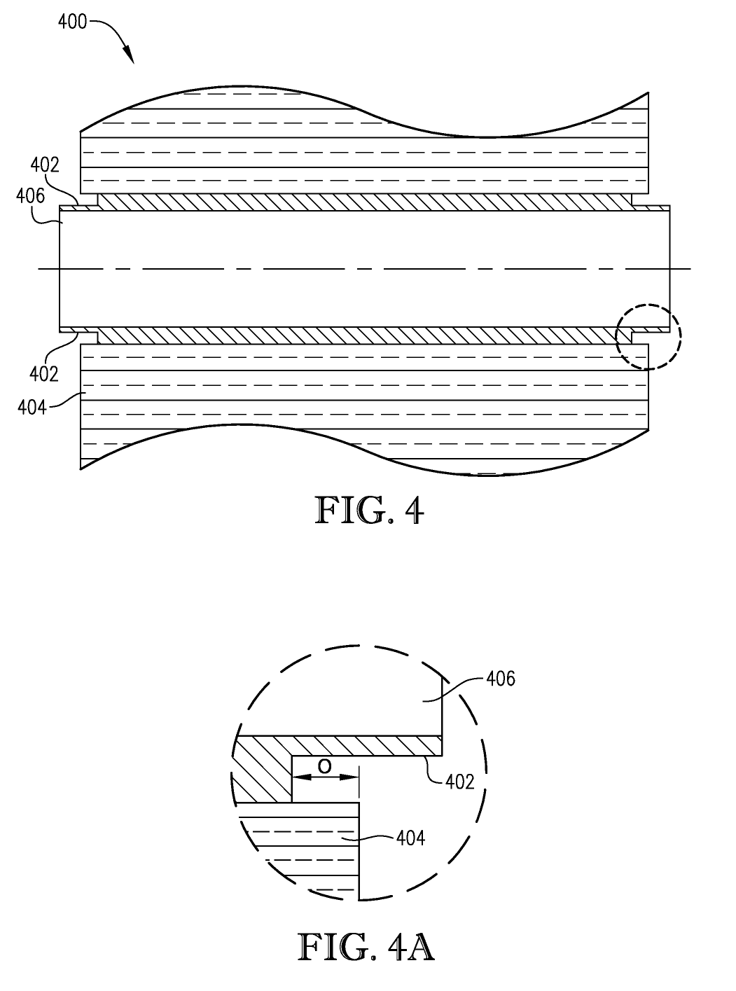

The spacers described herein can also be considered part of the rolling core. In various embodiments, the rolling cores have special designs on their surfaces that prevent or deter the formation of raised edges by releasing the high edge pressure. Several of these core designs are depicted in FIGS. 4-6.

FIG. 4 shows a cross-sectional view of a multilayered wound film roll 400 with a spacer 402 and a film 404 wound around a rolling core 406. As depicted in FIG. 4, the spacer 402 is formed from the surface of the rolling core 406 and has a right angle cut into its edges. The spacer 402 also has a narrower width compared to the film 404. This difference is emphasized in FIG. 4A, which shows a close-up view of the edges of the specially-designed spacer 402, film 404, and rolling core 406. As shown in FIG. 4A, since the edges of the film 404 extend past the edges of the spacer 402 to form an overhang (as depicted by “O”), the edges of the film 404 will be free of pressure from against the hard rolling core.

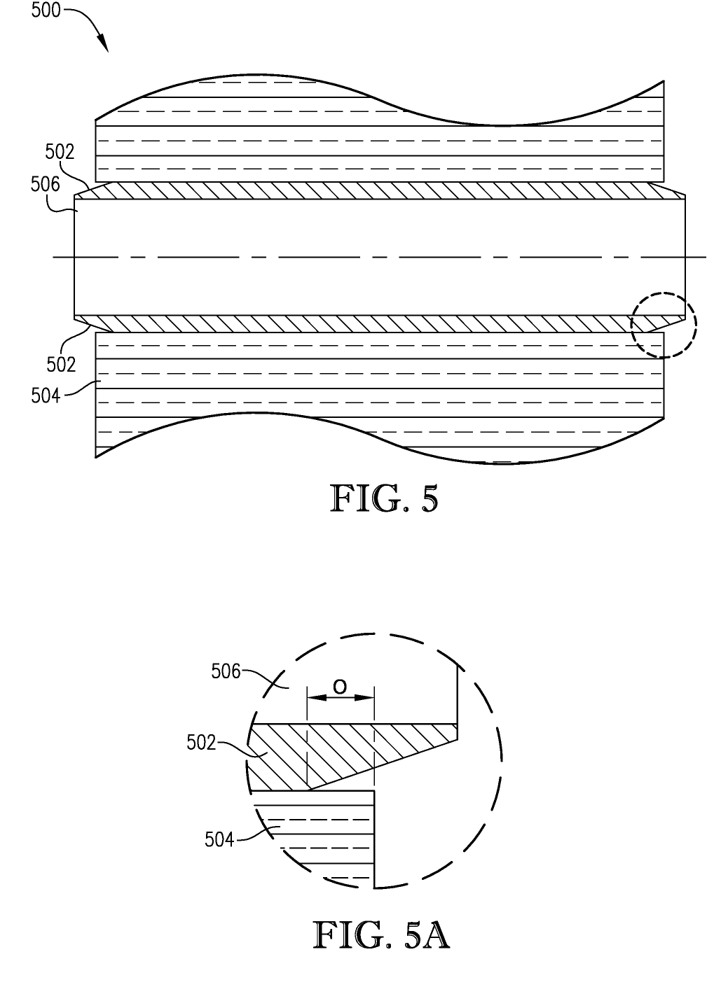

FIG. 5 shows a cross-sectional view of a multilayered wound film roll 500 with a spacer 502 and a film 504 wound around a rolling core 506. As depicted in FIG. 5, the spacer 502 is formed from the surface of the rolling core 506 and has a tapered design cut into its edges. The spacer 502 also has a narrower width compared to the film 504. This difference is emphasized in FIG. 5A, which shows a close-up view of the edges of the specially-designed spacer 502, film 504, and rolling core 506. As shown in FIG. 5A, since the edges of the film 504 extend past the edges of the spacer 502 to form an overhang (as depicted by “O”), the edges of the film 504 will be free of pressure from against the hard rolling core.

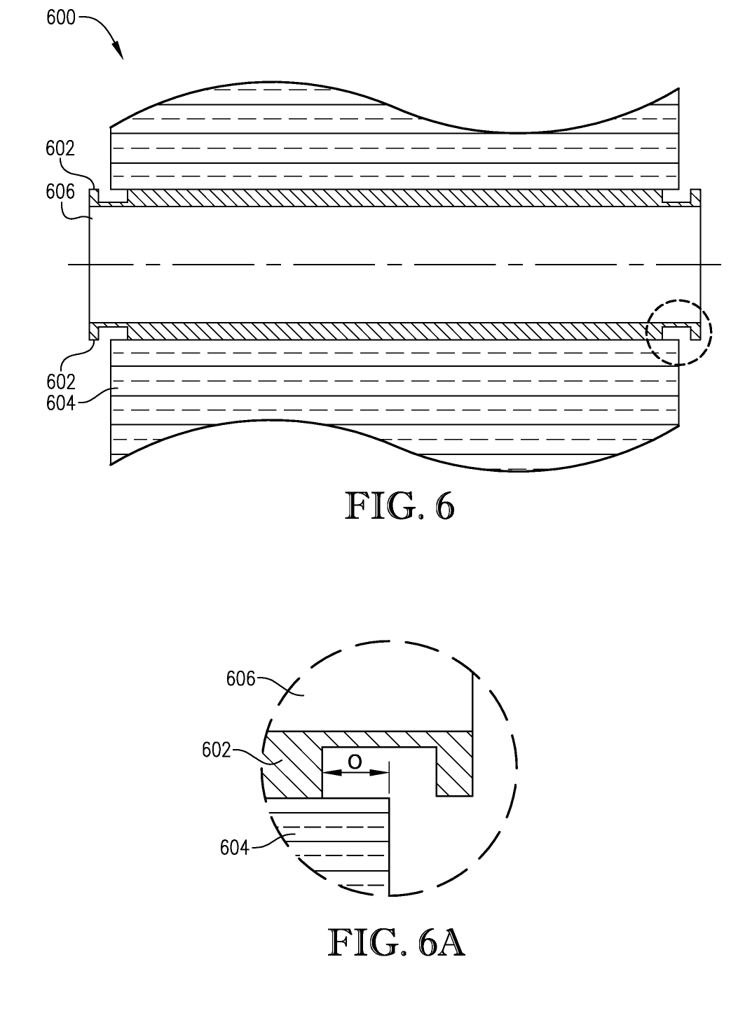

FIG. 6 shows a cross-sectional view of a multilayered wound film roll 600 with a spacer 602 and a film 604 wound around a rolling core 606. As depicted in FIG. 6, the spacer 602 is formed from the surface of the rolling core 606 and has a slotted design cut into its edges. The spacer 602 also has a narrower width compared to the film 604. This difference is emphasized in FIG. 6A, which shows a close-up view of the edges of the specially-designed spacer 602, film 604, and rolling core 606. As shown in FIG. 6A, since the edges of the film 604 extend past the edges of the spacer 602 to form an overhang (as depicted by “O”), the edges of the film 604 will be free of pressure from against the hard rolling core.

Additionally or alternatively, in various embodiments, the raised edges of the wound film can be reduced or prevented by entrapping a gas between the layers in the wound film, thereby reducing edge pressure and evening the uniformity of the wound film's edges. Consequently, raised edges can be prevented and reduced in the multilayered wound film roll by using the gas entrapping device and process described herein.

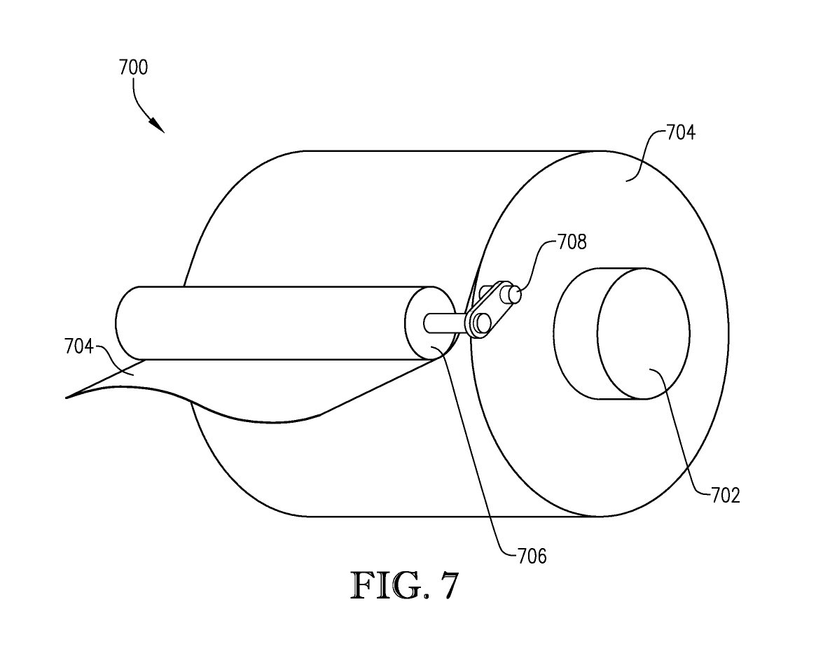

FIG. 7 depicts the gas entrapping device 700 during winding of a film. This device 700 can introduce a gas flow onto the inner surface of the film immediately before it is wound. As shown in FIG. 7, the gas entrapping device 700 comprises a roller 702 configured to wind a film 704 around a core to thereby form a wound film comprising a plurality of film layers. A rewind-controlling member 706 can maintain a constant distance from the outermost layer of the wound film 704 during winding on the roller 702. The rewind-controlling member 706 can keep constant tension on the film 704 thereby ensuring the distance from the roller 702 generally remains constant. A gas injection system 708 can be placed on the rewind-controlling member 706 and can introduce a gas between each of the film layers before the film layer is wound around the core. This entrapped gas can help reduce the edge pressure of the wound film and/or even the thickness non-uniformity between the film's edges. As the diameter of the wound film increases during the process of winding, the rewind-controlling member 706 and gas injection system 708 can move together to keep a proper direction and position for gas injection.

In certain embodiments, the rewind-controlling member can reduce the tension on the film during winding on the roller. In various embodiments, the rewind-controlling member can be a pivot arm or a lay-on roller. The injected gasses can include, for example, argon, nitrogen, oxygen, or a mixture thereof.

The gas entrapping device depicted in FIG. 7 can be used in any of the processes described above for producing the multilayered wound film roll. In one or more embodiments, the processes incorporating the gas entrapping device occur in a vacuum. Unlike the oscillating methods in the prior art, the gas entrapping device described herein allows a gas to be introduced between the layers while the winding occurs in a vacuum. During processes that incorporate the gas entrapping device, a gas can be injected between the film layers immediately before the film is wound around the central support assembly.

It should be noted that both a spacer and the gas entrapping device can be used to reduce raised edges in the present invention and that the two are not mutually exclusive. Alternatively, either a spacer or the gas entrapping device can be used alone without the need of the other.

Furthermore, the processes described herein can further comprise a coating deposition step as depicted in FIG. 1 that occurs prior to the above-described winding steps to produce the multilayered wound film rolls. For example, this coating step can involve unrolling a primary film from an initial roll and depositing at least one material onto the unwound primary film to form a coated film. This coated film can serve as the film described above to produce the multilayered wound film rolls. Like the winding steps described above, these steps can be carried out in a vacuum. In one or more embodiments, the depositing step can comprise sputter coating. Additionally or alternatively, the deposited coating material can comprise at least one metal and/or oxides thereof. For example, the metal can comprise indium, tin, and/or oxides thereof.

The finished multilayered wound film rolls described herein can be used in a broad range of applications and can be used directly in various applications or be subjected to further processing. For example, the multilayered wound film rolls described herein can be used to produce various electronics including, for example, optical films, touch panels, solar panels, and semiconductors. The finished multilayered wound film rolls can also be subjected to further processing such as, for example, being used in printing devices.

Furthermore, the size and diameter of the resulting multilayered wound film roll can be modified in accordance with the desired end use of the roll. For example, the multilayered wound film roll can have a diameter of at least about 10, 50, or 100 mm and/or not more than about 5,000, 2,500, or 1,000 mm. More specifically, the multilayered wound film roll can have a diameter in the range of 10 to 5,000 mm, 50 to 2,500 mm, or 100 to 1,000 mm.

The inventors hereby state their intent to rely on the Doctrine of Equivalents to determine and assess the reasonably fair scope of the present invention as it pertains to any apparatus not materially departing from but outside the literal scope of the invention as set forth in the following claims.

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

What is claimed is:

1. A multilayered wound film roll comprising a central support assembly and a film wound around said central support assembly,
wherein said central support assembly presents an outer support surface contacting an initial wound layer of said film,
wherein each wound layer of said film comprises a main film body and a pair of outer edges extending along opposite sides of said main film body,
wherein the average thickness of said outer edges is greater than the average thickness of said main film body,
wherein the width of said outer support surface is less than the width of said initial wound layer of said film so that said outer edges of said initial wound layer of said film are not in contact with said outer support surface.

2. The multilayered wound film roll of claim 1, wherein said outer edges of said film extend at least about 0.5 mm and not more than about 500 mm beyond the edges of said outer support surface.

3. The multilayered wound film roll of claim 1, wherein said central support assembly comprises a rolling core and a spacer disposed between said rolling core and said initial wound layer of said film, wherein said spacer presents said outer support surface.

4. The multilayered wound film roll of claim 3, wherein said spacer has an average thickness in the range of 0.1 to 500 mm.

5. The multilayered wound film roll of claim 3, wherein said spacer comprises a foam or a plurality of layers formed from a narrow leader film.

6. The multilayered wound film roll of claim 3, wherein said spacer and said rolling core are made from the same material, wherein said spacer is an extension of said rolling core.

7. The multilayered wound film roll of claim 1, wherein the average thickness of said outer edges of said film is at least 0.00001 percent and not more than 10 percent thicker than the average thickness of said main film body.

8. The multilayered wound film roll of claim 1, wherein each layer of said main film body has an average thickness of at least about 0.5 μm and not more than about 1,000 μm.

9. The multilayered wound film roll of claim 1, wherein said roll comprises at least about 100 and not more than about 100,000 wound layers of said film.

10. The multilayered wound film roll of claim 1, wherein said multilayered wound film roll has a diameter of at least about 10 mm and not more than about 5,000 mm.

11. A process for producing a multilayered wound film roll, said process comprising:
winding a film around a central support assembly to thereby form said multilayered wound film roll comprising a wound film,
wherein said central support assembly presents an outer support surface that contacts an initial wound layer of said film during said winding,
wherein each layer of said wound film comprises a main film body and a pair of outer edges extending along opposite sides of said main film body,
wherein the average thickness of said outer edges is greater than the average thickness of said main film body,
wherein the width of said outer support surface is less than the width of said initial wound layer of said film so that said outer edges of said initial wound layer of said film are not in contact with said outer support surface.

12. The process of claim 11, wherein said central support assembly comprises a rolling core and a spacer disposed between said rolling core and said initial wound layer of said film, wherein said spacer presents said outer support surface.

13. The process of claim 12, further comprising, prior to said winding, attaching said film to said spacer, wherein said spacer is wound onto said rolling core prior to said film.

14. The process of claim 12, wherein said spacer comprises a foam or a narrow leader film.

15. The process of claim 12, wherein said wherein said spacer and said rolling core are made from the same material, wherein said spacer is an extension of said rolling core.

16. The process of claim 11, wherein said process is carried out in a vacuum.

17. The process of claim 11, further comprising, prior to said winding, unrolling an initial roll comprising said film to obtain an unwound film and depositing at least one material onto said unwound film to thereby form a coated film, wherein said coated film is said film in said winding step.

18. A vacuum roll-to-roll device, said device comprising:
a roller configured to wind an initial film around a core thereby forming a wound film comprising a plurality of film layers;
a rewind-controlling member configured to maintain a constant distance from the outermost layer of said wound film during winding on said roller; and
a gas injection system configured to introduce a gas to be entrapped between said film layers during said winding on said roller, wherein the entrapped gas reduces the edge pressure of said wound film and minimizes the thickness variation in said wound film.

19. The vacuum roll-to-roll device of claim 18, wherein said gas injection system is affixed to said rewind-controlling member.

20. The vacuum roll-to-roll device of claim 18, wherein said rewind-controlling member comprises a pivot arm or lay-on roller.

21. The vacuum roll-to-roll device of claim 18, wherein said device is configured to operate in a vacuum.

22. A process for producing a multilayered wound film roll, said process comprising:
winding a film around a central support assembly to thereby form said multilayered wound film roll having a plurality of film layers;
wherein said winding occurs in a vacuum,
wherein a gas is injected between said film layers during said winding immediately before said film is wound around said central support assembly.

23. The process of claim 22, wherein said gas comprises argon, nitrogen, oxygen, or a mixture thereof.

24. The process of claim 22, prior to said winding, unrolling an initial roll comprising said film to obtain an unwound film and depositing at least one material onto said unwound film to thereby form a coated film, wherein said coated film is said film in said winding step.

25. The process of claim 23, wherein each layer of said multilayered wound film roll comprises a main film body and a pair of outer edges extending along opposite sides of said main film body, wherein the average thickness of said outer edges of said film is at least 0.001 percent and not more than 2 percent thicker than the average thickness of said main film body.
